(19) United States
(12) Patent Application Publication
(10) Pub. No.: US 2004/0148433 A1
(43) Pub. Date: Jul. 29, 2004

(54) namehopper

(76) Inventor: Lori Sardinas, Istanbul (TR)

Correspondence Address: LORI SARDINAS, CITLENBIK SOK. 11/5 BESIKTAS, ISTANBUL, ., TR

(21) Appl. No.: 10/248,531

(22) Filed: Jan. 27, 2003

(51) Int. Cl. G06F 15/16

(52) U.S. Cl. 709/245

(57) ABSTRACT

This web page will have a window where the web users will enter the name of the person or firm they want to reach. In case it is a firm, the web page will list the different sectors and countries where the customers of this web page operate as options to enable the web user to reach the one he/she is looking for.

### DETAILED DESCRIPTION

Namehopper is supposed to be a web sight which functions as a domain name forwarder.

It will forward the recognized name of a customer to the specific domain name owned again by that customer eliminating the problem of sharing common names for domains or any domain name problem caused by a party's having gotten that specific domain name before that customer. In other words, it will serve as a base to enable web users to reach parties who share common names

1. This web page will categorize the parties which share a common domain name according to country and business sector and make them reachable by their marketly recognized names in the web. it will enable a domain name to serve more than one party in the web.

2. As serving to real people with a name and a family name, this web page will be serving only to those who own that specific name and family name and disclose a form of id to prove it. Any person who have lost the chance of getting their own name and family names as their domain names—due to someone else has gotten it—will have the chance to be reached with their own names with the service of this web page.

3. This web page is designed to be used free of charge by the web users. Yet the customers of this web page—who are the parties sharing a common domain name—are to pay a yearly fee for the service of forwarding their customers who are web users to the specific domain address they specify.
